(19) United States
(12) Patent Application Publication
(10) Pub. No.: US 2001/0007710 A1
(43) Pub. Date: Jul. 12, 2001

(54) Abrasion-resistant decor sheet

(75) Inventors: Ann Xiaoan Liu, Pickering (CA); Douglas Ireland, Belleville (CA)

Correspondence Address: Law Offices of David J. Serbin, Unit 2 - First floor, 1423 Powhatan Street, Alexandria, VA, 22314, US

(73) Assignee: AKZO NOBEL N.V..

(21) Appl. No.: 09/741,443

(22) Filed: Dec. 21, 2000

Related U.S. Application Data
(60) Provisional application No. 60/171,526, filed on Dec. 22, 1999.

(30) Foreign Application Priority Data
Dec. 22, 1999 (EP) 99850207.4

(51) Int. Cl. B05D 3/02; B32B 3/00

(52) U.S. Cl. 428/207; 427/385.5; 427/391

(57) ABSTRACT

An abrasion-resistant decor sheet comprising a resin-impregnated substrate containing abrasion-resisting particles and a protective overlayer comprising expanded thermoplastic microspheres, a method of producing the decor sheet and a method of producing a decor laminate comprising the decor sheet.

The present invention relates to an abrasion-resistant decor sheet, a method of producing the sheet, a method of producing a decor laminate containing the sheet and a laminate produced thereof. The decor sheet according to the present invention comprises abrasion-resisting particles and a protective overlayer comprising expanded thermoplastic microspheres.

Abrasion-resistant decorative thermosetting laminates are well known in the art and used for instance as surface material for such applications where a high abrasion resistance is required. This is especially the case for flooring laminates, but also to a certain extent for desktop and tabletop laminates.

These laminates usually comprise a top surface, or overlay, or decor sheet consisting of an impregnated paper containing abrasive particles imparting abrasion resistance to the finished product. The abrasive particles used are hard particles having normally an average particle size of about 50 μm, which is advantageous for the abrasion resistance but not for the press plates used during the lamination stage. The press plates are scratched by the relatively big particles in the surface of the laminate. These plates are very expensive and manufactured of high quality steel. Intermediate layers of aluminium foil are often used to protect these press plates which will affect the production cost.

An attempt to solve the above mentioned problem with the press plates is described in WO 97/00172 A1. A process for manufacturing an abrasion- and scratch-resistant decorative thermosetting laminate is disclosed, wherein the surface layer of the laminate, consisting of an overlay of a paper web or sheet, is first impregnated with a melamine-formaldehyde resin, then coated on one side with abrasive particles with an average particle size of 30-90 μm, whereafter the resin is dried. Then the other side of the sheet, or alternatively another sheet is coated with a melamine-formaldehyde resin containing abrasive particles with an average particle size of 1-15 μm, whereafter the resin is dried. The surface containing the smaller particles is placed outwards on the top of the laminate, while the larger particles are incorporated into the lower side of the surface sheet, or on the topside of the sheet directly under the surface sheet. This arrangement will give a good abrasion resistance to the finished product.

However, technical solutions are still sought for the need to increase the abrasion resistance of decor sheets and decrease the wear of the press plates during the lamination step and at the same time keep the production cost low.

According to the invention it has been found that the use of a protective overlayer containing expanded thermoplastic microspheres on a decor sheet significantly diminishes wear of the press plates, improves the abrasion resistance of the resulting decor sheet and does not affect transparency.

The present invention accordingly provides an abrasive-resistant decor sheet, a method of producing this sheet, a laminate comprising the decor sheet, a method of producing a laminate comprising the sheet and a laminate obtainable by this method, by which the above mentioned problems are overcome.

The decor sheet according to the invention is defined in the appended claims. It comprises a resin-impregnated paper containing abrasion-resisting particles and a protective overlayer comprising expanded thermoplastic microspheres.

By “overlayer” is herein meant a layer or coating on the top surface of the decor sheet or overlay.

Expandable thermoplastic microspheres suitable for use in the present invention have a polymer shell enclosing an expanding agent, which is evaporated at the application of heat. The polymer shell may consist of a copolymer of monomers selected from the group: acrylonitrile, methacrylonitrile, alpha-ethoxyacrylonitrile, alpha-chloroacrylonitrile, fumaronitrile, vinylidene chloride, vinyl chloride, methacrylic ester, acrylic ester, styrene, vinyl acetate, butadiene, neoprene and mixtures thereof. The thermoplastic microspheres may be produced in conventional fashion, for instance as set forth in U.S. Pat. No. 3,615,972, which hereby is incorporated by reference. Furthermore, copolymers of methyl methacrylate containing up to about 20 percent by weight styrene, copolymers of methyl methacrylate and up to about 50 percent by weight of combined monomers of ethyl methacrylate, copolymers of methyl methacrylate and up to about 70 percent by weight of orthochlorostyrene may be mentioned. The particle size of the expandable microspheres may vary within broad limits and is chosen with respect to the properties desired for the finished product. Suitable examples of particles sizes for the expandable microspheres could be 1 μm to 1 mm, preferably 2 μm to 0.5 mm and most preferably 5 μm to 50 μm. On expansion the diameter of the microspheres increases by a factor 2-5. The expanding agent may consist of freones, hydrocarbons, such as n-pentane, isopentane, neopentane, butane, isobutane, or other blowing agents that are used conventionally in microspheres of the type specified herein. Suitably 5-30 percent by weight of the microspheres may consist of expanding agent.

Expandable thermoplastic microspheres are distinguished by their capacity to begin to expand at a certain temperature(Tₛₜₐᵣₜ). They then increase in volume when the temperature is raised, up to a certain temperature (Tₘₐₓ) at which the increase in volume stops, but before the microspheres start to collapse. A further temperature increase then results in a decrease in volume, resulting from the collapse of the microspheres. This expansion process is irreversible. The Tₛₜₐᵣₜ and Tₘₐₓ depend on which expandable thermoplastic microspheres are chosen for that particular use and on the heating rate. Normally, Tₛₜₐᵣₜ varies between 60-126° C. and Tₘₐₓ between 115-150° C.

Suitable curable resins for use in the present invention are thermosetting resins, such as melamine resins, for example, melamine-formaldehyde, urea resins, for example, urea-formaldehyde, phenolic resins, for example, phenol-formaldehyde, or mixtures thereof. Melamine-formaldehyde resins are preferred.

The abrasion resisting particles that are incorporated in the decor sheet according to the invention may consist of many different materials having a hardness of 7 or more on the Moh hardness scale. Materials containing silicon dioxide, aluminium oxide, silicon carbide, ceramic particles, and mixtures thereof may be used. Depending on which material the abrasive particles are based on and the end-use properties desired in the laminates to be manufactured using the decor sheet of this invention, the particle size may, for example, range from 10 to 150 microns, suitably from 30 to 90 microns and preferably from 35 to 70 microns. The particles incorporated into the decor sheet should be in a sufficient quantity to impart the desired degree of abrasion resistance to the finished product. Suitably 5-70 g/m² of particles, preferably 10-50 g/m², and most preferably 20-40 g/m² are incorporated into the impregnated paper.

The decor sheet or overlay according to the present invention is particularly suitable for use where a high abrasion resistance is required, for example, for flooring, desktop, or tabletop laminates.

The method of manufacturing the decor sheet according to the present invention is defined in the appended claims, wherein a substrate containing a curable resin, abrasion-resisting particles and expandable thermoplastic microspheres is dried at a temperature, at which the microspheres expand and the resin at least partially cures.

The sheet impregnated with a curable resin containing expandable thermoplastic microspheres is suitably sequentially dried, whereby the microspheres expand. The temperature at which the particles start to expand (Tstart °C.) may vary depending on the chosen microspheres and the rate of heating. At raising the temperature, the microspheres continue to expand to their full size until the Tmax is reached. A further temperature increase after this point would cause collapse of the microspheres. On expanding, the microspheres float on the top of the resin forming a protective layer on the top surface of the decor sheet, which may be continuous or discontinuous. Suitably the protective layer covers more than 75%, preferably more than 90%, of the top surface of the decor sheet. This protective overlayer acts effectively during lamination, as a cushion between the press plates and the abrasive particles in the decor sheet.

The substrate used in the method of the invention for making abrasion-resistant decor sheet, though usually paper, may be any type of impregnable substrate, including such as woven and non-woven textiles. The substrate is normally printed, coloured or otherwise decorated, if it is intended for decorative purposes. The paper used, normally has a weight of about 20 to about 250 g/m², more typically about 60 to about 100 g/m².

The substrate can be impregnated with curable resin by various conventional techniques of applying resin compositions, such as baths, rollers, doctor blades, air knife, metering roll, doctor bars, etc. The resin compositions can be applied in one or more steps with drying and/or partial curing between the application stages.

The abrasive particles can be incorporated into the resin-impregnated substrate by various methods known in the art. The particles can be added to the substrate during impregnation of the substrate with a curable resin containing the particles, or they can be applied onto the substrate after it has been impregnated with a curable resin, for example by spraying. It is also possible to incorporate the particles into the substrate before it is impregnated with a curable resin. Preferably, the particles are added to the substrate during impregnation with a curable resin containing the particles.

The addition of the expandable thermoplastic microspheres to the substrate, suitably takes place after the addition of the abrasion-resisting particles to the substrate and preferably at a subsequent impregnation bath.

The amount of expandable thermoplastic microspheres added to the impregnating solution may vary within broad limits, depending on the desired properties of the finished product. Suitably an amount of 0.1-5% by weight microspheres, preferably 0.5-2% by weight and most preferably 0.5-1% by weight, based on the weight of the curable resin, may be added to the impregnating solution.

The curable resin in the decor sheet is at least partially cured to the so-called B-stage. It should be noted in this context that a thermosetting resin in the A-stage is liquid, poorly cross-linked and partially soluble in water. A C-stage resin is not meltable, completely cross-linked and insoluble. The B-stage is a stage between the A-stage and the C-stage. A resin in B-stage is meltable under heat and pressure. Decor sheets that are partially cured are usually bonded to a core by laminating under heat and pressure, whereby final curing of the resin takes place.

The abrasion-resistant decor sheets obtainable by the method according to the present invention can be used for both high-pressure and low-pressure laminates.

The abrasion-resistant decor laminate comprising the decor sheet according to the present invention is defined in the appended claim, wherein the thermoplastic microspheres in the overlayer are collapsed.

The method of manufacturing a laminate comprising the decor sheet according to the present invention is defined in the appended claim, wherein the abrasion-resistant decor sheet according to the invention is bonded to a core comprising at least one layer, at such a temperature and pressure, at which the expanded thermoplastic microspheres collapse and the resin fully cures. As a result of that the microspheres collapse during lamination, the transparency of the finished abrasion-resistant laminates is essentially not affected at all. Suitably the temperature and the pressure during lamination lie between 130-200° C., respectively 1.6-3.1 MPa and preferably between 150-170° C., respectively 1.77-2.9 MPa.

The core of the laminate may be of any desired type, and such cores as wood, particle-board, fibre-board, plywood and the like can be used, as well as a number of conventional dry prepreg webs or sheets impregnated with resins such as phenol-formaldehyde or phenol-urea-formaldehyde resins.

The present invention is illustrated by means of some non-limiting examples below.

### EXAMPLES

Example 1. A decorative paper web was impregnated with a melamine-formaldehyde (MF) resin solution containing abrasive particles of aluminium oxide having a particle size of between 10 μm and 100 μm in an amount of 35% by weight, based on the weight of the resin, whereupon the web was dried at a temperature of between 60 to 98° C. Thereafter the web was impregnated with a MF-resin solution containing expandable thermoplastic microspheres, Expancel WU642 (Tstart, 84-90° C. and Tmax, 125-133° C.), in an amount of 0.5% by weight, based on the weight of the resin. The web was subsequently dried in a dryer with a temperature profile of 90-160° C., whereby the microspheres were expanded to their full size and the resin was partially cured (B-stage).

Example 2. The example 1 was repeated except that an amount of 0.6% Expancel WU642 by weight, based on the weight of the resin was used.

Example 3. The example 1 was repeated except that an amount of 0.75% Expancel WU642 by weight, based on the weight of the resin was used.

Example 4. (Comparison) A decor sheet was produced in the same manner as in example 1, but without expandable thermoplastic microspheres.

Example 5. (Comparison) Another decor sheet was produced in the same manner as in example 1, but without expandable thermoplastic microspheres.

Pieces of the webs prepared according to the examples above were pressed on MDF (Medium density fibre)-board under the same process conditions, P=1.77 MPa and T=195° C., for 30 seconds, whereby the resin was fully cured and the expanded Expancel microspheres were collapsed.

The pressed products showed the same transparency with or without a protective layer containing collapsed thermoplastic microspheres.

The abrasion resistance of the finished products was measured according to a standard method, by the Taber abrasion test conformed to NEMA:LD3.13 (1995) According to this method a test specimen is placed on a turntable and is being rubbed by an abrader wheel (rubber wheel 33) supplied with sandpaper. The sandpaper strips (Taber S42) were renewed after every 500 revolutions. According to this standard the abrasion through the decorative layer of the finished laminates is measured in two steps. In the first step the IP (Initial Point) is measured, where the initial abrasion starts and in the second step the FP (Final Point), where the whole decor is worn through. The abrasion resistance is defined as the algebraic sum of the Initial Point average of the samples and the Final Point average of the samples divided by 2 and multiplied by a correction factor, which is calculated according to this standard for each lot of sandpaper used.

In order to estimate the wear of the press plates by the abrasion-resistant decor sheet during pressing, a modified version of the above mentioned standard method was developed. The sandpaper was replaced by the decor sheet produced according to the invention and the Taber test was performed on a standard laminated board, which does not comprise abrasion-resisting particles. The number of revolutions at IP is used as a measure of the scratch degree on the press plates caused by the decor sheet during pressing. The higher the IP value the fewer scratches on the press plates, i.e., less wear of the press plates.

The results of the abrasion-resistance and the wear of the press plates measurements, expressed in IP values, are shown in the Table below.

TABLE

| | Abrasion | Press plate wear |
|---|---|---|
| Example nr | IP (revolutions) | IP (revolutions) |
| 1 | 6000 | 200 |
| 2 | 7000 | 200 |
| 3 | 10000 | 200 |
| 4 | 6000 | 50 |
| 5 | 7000 | 50 |

As shown by the test results above, the use of a protective overlayer comprising thermoplastic microspheres according to the present invention, effectively diminishes the wear of the press plates during lamination, while the abrasion resistance of the finished laminates is not affected.

1. An abrasion-resistant decor sheet comprising a resin-impregnated substrate containing abrasion-resisting particles, characterised in that it comprises a protective overlayer containing expanded thermoplastic microspheres.

2. An abrasion-resistant decor sheet according to claims 1, characterised in that the substrate is a paper.

3. An abrasion-resistant decor sheet according to any one of claims 1 or 2, characterised in that the abrasion resisting particles contains aluminium oxide, silicon carbide, ceramic materials and mixtures thereof.

4. An abrasion-resistant decor sheet according to claim 3, characterised in that the abrasion resisting particles have an average particle size of about 35-70 μm.

5. An abrasion-resistant decor sheet according to any one of the preceding claims, characterised in that the resin is a partially cured melamin-formaldehyde resin, a urea-formaldehyde resin, a phenolic resin, and mixtures thereof.

6. A method of producing an abrasion-resistant decor sheet, characterised in that a substrate containing a curable resin, abrasive-resisting particles and expandable thermoplastic microspheres is dried at a temperature, at which the microspheres expand and the resin partially cures.

7. A method of producing an abrasion-resistant decor sheet according to claim 6, characterised in that the substrate is first impregnated with a curable resin and furnished with abrasive-resisting particles, whereafter in a subsequent step it is impregnated with a curable resin containing expandable microspheres.

8. A method of producing an abrasion-resistant decor sheet according to any one of claims 6 or 7, characterised in that the abrasion-resisting particles are incorporated into the substrate by impregnation of the substrate with a curable resin containing the particles.

9. A method of producing an abrasion-resistant decor sheet according to any one of claims 6-8, characterised in that the expandable thermoplastic microspheres are present in an amount of 0.5-2.0% by weight based on the weight of the curable resin.

10. A method of producing an abrasion-resistant decor sheet according to any one of claims 6-9, characterised in that the substrate is a paper.

11. A method of producing an abrasion-resistant decor sheet according to any one of claims 6-10, characterised in that the curable resin is a melamine-formaldehyde resin, a urea-formaldehyde resin, a phenolic resin, and mixtures thereof.

12. An abrasion-resistant decor sheet obtainable by the method according to any one of claims 6-11.

13. An abrasion-resistant decor laminate comprising a core of at least one layer bonded to an abrasion-resistant decor sheet according to any one of claims 1-12 wherein the thermoplastic microspheres are collapsed.

14. A method of producing an abrasion-resistant decor laminate, characterised in that an abrasion resistant decor sheet according to any one of claims 1-12, is bonded to a core comprising at least one layer, at a temperature and pressure at which the expanded thermoplastic microspheres collapse and the resin fully cures.

15. An abrasion-resistant decor laminate obtainable by the method according to claim 14.
